(19) United States
(12) Patent Application Publication
(10) Pub. No.: US 2005/0286723 A1
(43) Pub. Date: Dec. 29, 2005

(54) QKD system network

(75) Inventors: Harry Vig, North Billerica, MA (US); Andrius Berzanskis, Cambridge, MA (US)

Correspondence Address: OPTICUS IP, 7791 ALISTERMACKENZIE DRIVE, SARASOTA, FL, 34240, US

(73) Assignee: MagiQ Technologies, Inc.

(21) Appl. No.: 11/152,875

(22) Filed: Jun. 15, 2005

Related U.S. Application Data
(60) Provisional application No. 60/583,515, filed on Jun. 28, 2004.

(51) Int. Cl. H04L 9/00

(52) U.S. Cl. 380/278

(57) ABSTRACT

QKD system networks (50, 200, 300) and methods of communicating between end-users (P1, P2) over same are disclosed. An example QKD system network (50) includes a first QKD station (A1) and a second QKD station (A2) with a relay station (58) in between. The relay station includes a single third QKD station (B) and an optical switch (55). The optical switch allows the third QKD station to alternately communicate with the first and second QKD stations so as to establish a common key between the first and second QKD stations. The end-users are coupled to respective QKD stations A1 and A2. A secret key (S) is shared between P1 and P2 by QKD station B being able to independently form keys with A1 and A2. This basic system, represented as P1-A1-B-A2-P2, can be expanded into more complex linear networks, such as P1-A1-B1-A2-B2-P2 with B1 and A2 making up the relays. The basic QKD system network can also be expanded into multi-dimensions.

### CLAIM OF PRIORITY

This application claims priority from U.S. Provisional Patent Application No. 60/583,515, filed on Jun. 28, 2004.

### FIELD OF THE INVENTION

The present invention relates to quantum cryptography, and in particular relates to a quantum key distribution (QKD) system network.

### BACKGROUND OF THE INVENTION

Quantum key distribution involves establishing a key between a sender (“Alice”) and a receiver (“Bob”) by using weak (e.g., 0.1 photon on average) optical signals transmitted over a “quantum channel.” The security of the key distribution is based on the quantum mechanical principle that any measurement of a quantum system in unknown state will modify its state. As a consequence, an eavesdropper (“Eve”) that attempts to intercept or otherwise measure the quantum signal will introduce errors into the transmitted signals, thereby revealing her presence.

The general principles of quantum cryptography were first set forth by Bennett and Brassard in their article “Quantum Cryptography: Public key distribution and coin tossing,” Proceedings of the International Conference on Computers, Systems and Signal Processing, Bangalore, India, 1984, pp. 175-179 (IEEE, New York, 1984). The general process for performing QKD is described in the book by Bouwmeester et al., “The Physics of Quantum Information,” Springer-Verlag 2001, in Section 2.3, pages 27-33. Specific QKD systems are described in publications by C. H. Bennett et al entitled “Experimental Quantum Cryptography,” J. Cryptology, vol. 5 (1992) ppp. 3-28, and by C. H. Bennett entitled “Quantum Cryptography Using Any Two Non-Orthogonal States”, Phys. Rev. Lett. 68 3121 (1992), as well as in U.S. Pat. No. 5,307,410 to Bennett (the '410 patent). The two Bennett references, as well as the '410 patent, are incorporated by reference herein.

The above mentioned publications each describe a so-called “one-way” QKD system wherein Alice randomly encodes the polarization or phase of single photons, and Bob randomly measures the polarization or phase of the photons. The one-way system described in the Bennett 1992 papers and in the '410 patent is based on a shared interferometric system. Respective parts of the interferometric system are accessible by Alice and Bob so that each can control the phase of the interferometer. The signals (pulses) sent from Alice to Bob are time-multiplexed and follow different paths. As a consequence, the interferometers need to be actively stabilized during transmission to compensate for thermal drifts.

U.S. Pat. No. 6,438,234 to Gisin (the '234 patent), which patent is incorporated herein by reference, discloses a so-called “two-way” QKD system that is autocompensated for polarization and thermal variations. Thus, the two-way QKD system of the '234 patent is less susceptible to environmental effects than a one-way system.

It will be desirable to one day have multiple QKD links woven into an overall QKD network that connects its QKD endpoints via a mesh of QKD relays or routers. Example QKD networks are discussed in the publication by C. Elliott et al., entitled “Quantum Cryptography in Practice,” New Journal of Physics 4 (2002), 46.1-46.12, as well as in PCT patent application publications no. WO 02/05480, WO 01/95554 A1, and WO 95/07852. U.S. Pat. No. 5,764,765 to Phoenix et al discloses several QKD network topologies without relays or routers, where the longest link is subject to specific distance limitations.

When a given point-to-point QKD link within the network fails—e.g. by fiber cut or from too much eavesdropping or noise—that link is abandoned and another used instead. Such a network can be engineered to be resilient even in the face of active eavesdropping or other denial-of-service attacks.

QKD networks can be constructed in several ways. In one example, the QKD relays only transporting keying material. After relays have established pair-wise agreed-to keys along an end-to-end point, e.g., between the two QKD endpoints, they employ these key pairs to securely transport a key “hop by hop” from one endpoint to the other. The key is encrypted and decrypted using a onetime-pad with each pairwise key as it proceeds from one relay to the next. In this approach, the end-to-end key will appear “in the clear” within the relays' memories proper, but will always be encrypted when passing across a link. Such a design may be termed a “key transport network.”

Alternatively, QKD relays in the network may transport both keying material and message traffic. In essence, this approach uses QKD as a link encryption mechanism, or stitches together an overall end-to-end traffic path from a series of QKD-protected tunnels. Such QKD networks have advantages that overcome the drawbacks of point-to-point links enumerated above.

First, they can extend the geographic reach of a network secured by quantum cryptography, since wide-area networks (WANs) can be created by a series of point-to-point links bridged by active relays. Links can be heterogeneous transmission media, i.e., some may be through fiber, while others are free-space. Thus, in theory, such a network could provide fully global coverage.

Second, they lessen the chance that an adversary could disable the key distribution process, whether by active eavesdropping or simply by cutting an optical fiber link. A QKD network can be engineered with as much redundancy as desired simply by adding more links and relays to the mesh.

Third, QKD networks can greatly reduce the cost of large-scale interconnectivity of private enclaves by reducing the required N×(N−1)/2 point-to-point links to as few as N links in the case of a simple star topology for the key distribution network.

Such QKD networks do have their own drawbacks, however. For example, their prime weakness is that the relays must be trusted. Since keying material and—directly or indirectly—message traffic are available in the clear in the relays' memories, these relays must not fall into an adversary's hands. They need to be in physically secured locations and perhaps guarded if the traffic is truly important. In addition, all users in the system must trust the network (and the network's operators) with all keys to their message traffic. Thus, a pair of users that need to share unusually sensitive information (traffic) must expand the circle of those who can be privy to it to include all machines, and probably all operators, of the QKD network used to transport keys for this sensitive traffic.

FIG. 1 is a schematic diagram of a simple prior-art point-to-point quantum key distribution (QKD) system network 10. P1 and P2 are users' terminals. Link L1 connects user terminal P1 with a QKD station A (Alice, for example) and link L3 connects user terminal P2 with a QKD station B (Bob, for example). It is supposed that links L1 and L3 are not encrypted and are situated within secure locations, as are as stations P1 and A and stations P2 and B. Link L2 connects two QKD stations A and B. This arrangement is limited by a maximum secure distance for QKD of between about 50-100 km. The configuration of QKD system 10 can be represented in shorthand notation as P1-A-B-P2. P1 and P2 are also referred to herein as “end-users.”

To extend the distance over which the key can be transmitted, one can use an intermediate relay station. The simplest embodiment of this configuration is the prior art QKD system network 20 shown in FIG. 2. QKD system 20 includes a relay station 30. Relay station 30 has two QKD stations A1 and B1 linked to corresponding QKD stations A and B, which attached to respective user terminals P1 and P2. The configuration of QKD system 20 is P1-A-B1-A1-B-P2. However, this configuration is relatively complicated and expensive because it requires two QKD stations for the relay station 30. Replicating this configuration for an even larger commercially viable QKD network very quickly becomes an expensive and unwieldy proposition.

### SUMMARY OF THE INVENTION

The present invention relates to QKD system networks. An example QKD system network according to the present invention includes first and second QKD stations optically coupled to a relay station in between. The relay station includes a single third QKD station and an optical switch. The optical switch allows the third QKD station to alternately communicate with the first and second QKD stations so as to establish a common key between the first and second QKD stations. End-users P1 and P2 are respectively coupled to QKD stations A1 and A2. A secret key (S) can be shared between P1 and P2 by B being able to independently form keys between B and A1 and B and A2 by adjusting the state of the optical switch.

This basic QKD system network, whose configuration can be represented as P1-A1-B-A2-P2, can be expanded into more complex linear networks, such as P1-A1-B1-A2-B2-P2 with B1 and A2 making up the switchable relays. The basic QKD system network can also be expanded into multi-dimensions.

These and other aspects of the invention are discussed in detail below.

### BRIEF DESCRIPTION OF THE DRAWINGS

FIG. 1 is a schematic diagram of a prior art point-to-point QKD system (link) arranged as P1-A-B-P2;

FIG. 2 is a schematic diagram of a prior art QKD system that includes a relay station that itself has two QKD stations A and B, the QKD system network having a P1-A-B1-A2-B-P2 configuration;

FIG. 3 is a schematic diagram of a QKD system according to the present invention that is similar to the QKD system of FIG. 2, but wherein the configuration is P1-A1-B-A2-P2, and wherein the relay station has a single QKD station B and a switch that allows for QKD station B to communicate with either of two QKD stations A1 and A2;

FIG. 4 is a high-level schematic diagram of an example QKD station for Alice or Bob according to the present invention, illustrating an optical connection between the switch and the quantum optics layer and an electrical connection between the switch the station's controller, the electrical connection enabling the controller to change the state of the optical switch;

FIG. 5 is a schematic diagram of a QKD system network as a one-dimensional grid configured as P1-A1-B1-A2-B2-P2, wherein B1 and A2 include optical switches, and illustrating the keys exchanged between adjacent QKD stations in the network;

FIG. 6 is a schematic diagram of a QKD system network as a two-dimensional grid, illustrating the keys exchanged between adjacent QKD stations; and

FIGS. 7 and 8 set forth a flowchart of an example embodiment of the operations needed to transmit a secret key S from P1 to P2 via a chain of QKD stations shown in the QKD system network of FIG. 5.

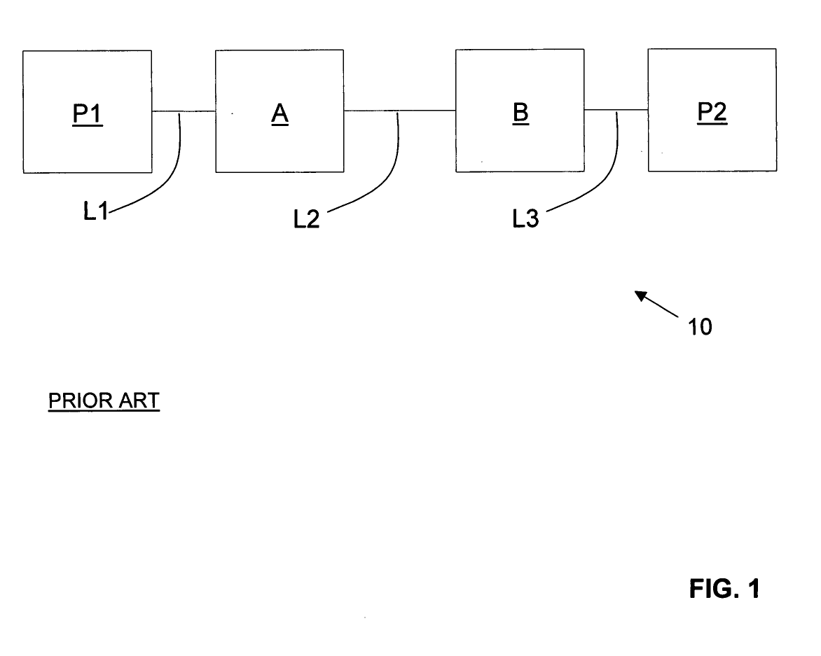

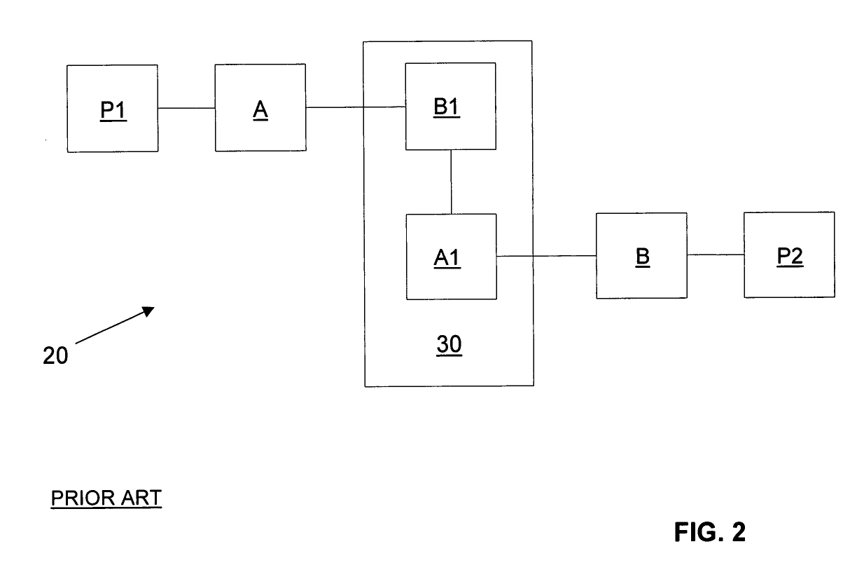

The various elements depicted in the drawings are merely representational and are not necessarily drawn to scale. Certain sections thereof may be exaggerated, while others may be minimized. The drawings are intended to illustrate various embodiments of the invention that can be understood and appropriately carried out by those of ordinary skill in the art.

### DETAILED DESCRIPTION OF THE INVENTION

The present invention allows for a chain of intermediate (“relay”) stations to be organized in a less expensive manner than prior art QKD system networks by adding optical path switches to the Alice and/or Bob QKD stations (“boxes”) between the two end-users. The switches allow for the relay stations to have a single QKD station that interacts with adjacent QKD stations depending on the state of the optical switch.

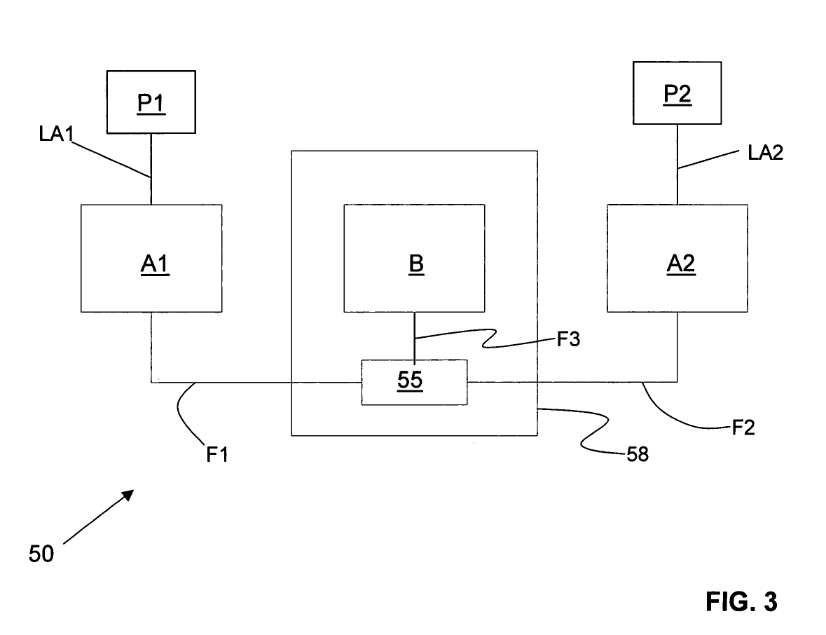

FIG. 3 is a schematic diagram of a QKD system 50 according to the present invention. QKD system includes an optically-lined cascaded chain of boxes A1, B and A2. The configuration of QKD system 50 can be represented in shorthand as P1-A1-B-A2-P2, wherein P1 and P2 are the end-users operably coupled to respective QKD stations A1 and A2 via links LA1 and LA1. In the QKD system 50, only Bob (B) is connected to or includes an optical switch 55 that allows B to establish a connection with either A1 or A2, e.g., via optical fiber links F1, F2 and F3. This arrangement allows only consecutive connections. In system 60, QKD station B and switch 55 constitute a relay 58.

For example, suppose B first chooses the switch position that allows QKD exchange with A1. After both A1 and B share a key k1, then the position (state) of the switch is changed so that B establishes a connection with A2 to share a key k2 with A2. At this point, B has two keys k1 and k2. To send a secret key S from P1 to P2, one can send it from P1 to A1 to B using one-time pad encryption with k1, decrypt it at B with k1, one-time pad encrypt it at B with k2, send it to A2, and decrypt it at P2 with k2.

Alternatively, it is possible to create c=k1 XOR k2 and keep it at B instead of keeping separate keys k1 and k2, which can be erased. Then at P1, the operation c1=S XOR k1 is performed, and c1 is sent to B, where c2 is created as c2=c1 XOR c. B then sends c2 to A2-P2, and at P2 the operation c2 XOR k2 is performed, thus revealing secret key S at P2.

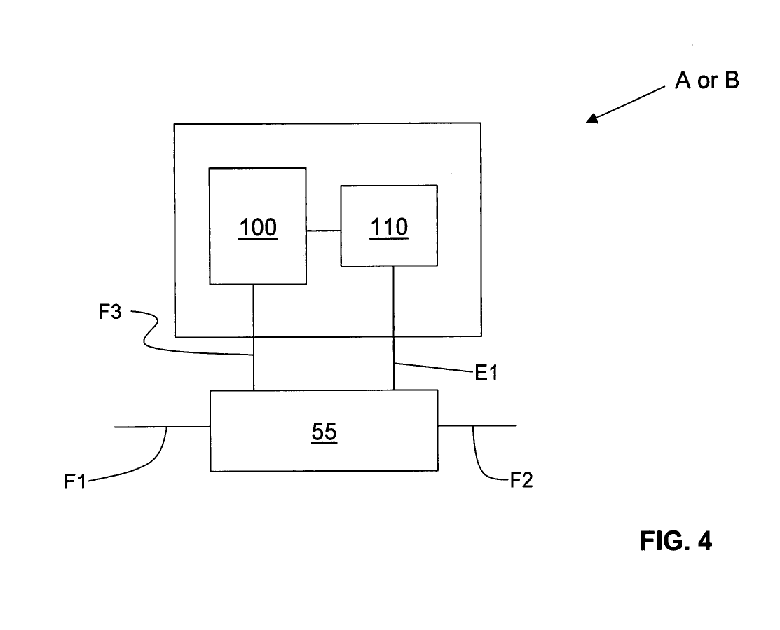

FIG. 4 is a high-level schematic diagrams of QKD station Alice (A) or Bob (B) according to the present invention. The QKD station (A or B) includes a quantum optics layer 100 operably coupled to a controller 110. Quantum optics layer 100 and controller 110 are operably coupled to switch 55, e.g., via optical fiber link F3 and an electrical link E1. Electrical link E1 allows for controller 110 to set the position or “state” of switch 55. For a “one-dimensional” grid of QKD stations (discussed below), switch 55 is, for example, a 1×2 optical switch—for example, a micro-electrical-mechanical system (MEMS) switch.

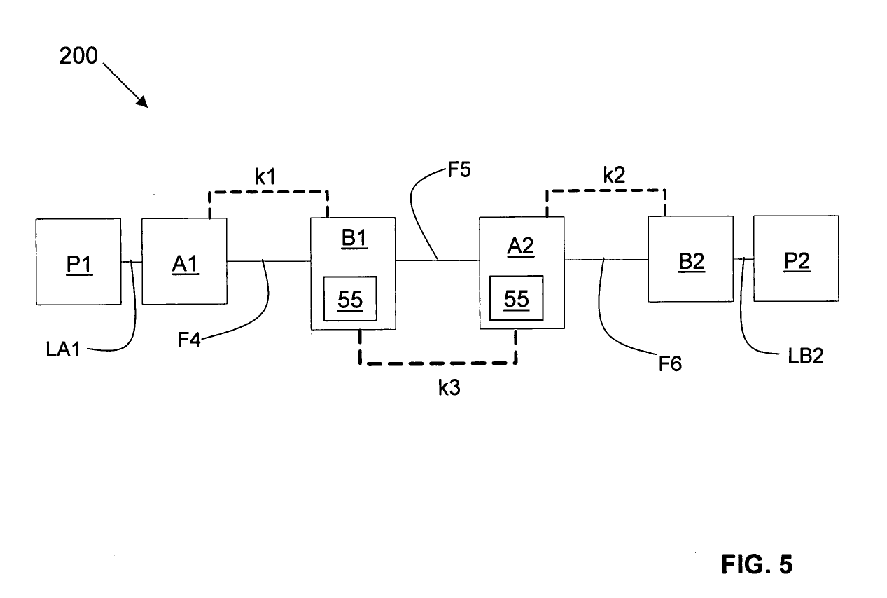

FIG. 5 is a schematic diagram of a QKD system network 200 in the form of a one-dimensional grid configuration, which can be represented in shorthand as P1-A1-B1-A2-B2-P2. Stations A1 and B1 are optically coupled by an optical fiber link F4, stations B1 and A2 are optically coupled by an optical fiber link F5, and stations A2 and B2 are optically coupled by an optical fiber link F6. End-users P1 and P2 are operatively coupled to respective QKD stations A1 and B2 via links LA1 and LB2.

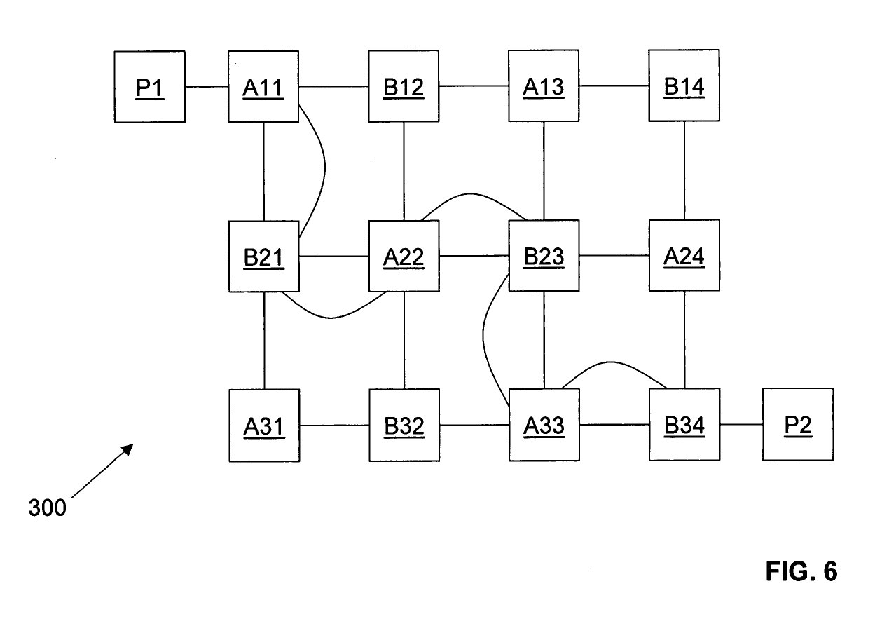

For QKD system 200, switches 55 in the form of 1×2 switches are necessary at QKD stations B1 and A2. For “two-dimensional” mesh grids such as QKD system network 300 of FIG. 6 (discussed below), 1×4 switches 55 (not shown) can be used. In general, each Bob or Alice station comprises a corresponding quantum optical layer 100, controller 110 and switch 55, as shown in FIG. 4. Controller 110 governs the timing and synchronization of the quantum optical layer components (not shown), such as phase (polarization) modulators, lasers, single photon detectors, VOA, etc. Controller 110 assures communication between stations in the network, and controls the operation of switches 55 in the network to provide a select optical path. Each controller 110 also records keys established with neighboring stations, and performs mathematical operations with the keys, such as the XOR operations discussed above.

It should be noted that links between different stations can be of different length, wherein each length corresponds a secure number of photons per pulse when weak coherent pulses are used. Also, different portions or segments of the system may suffer different environmental effects, thus requiring the controllers to operate with different sets of parameters. For example, station B1 in system 200 of FIG. 5 can have two sets of operating parameters—one set for the B1-A1 link and one set for the B1-A2 link. Different links may require different times for secure key distribution.

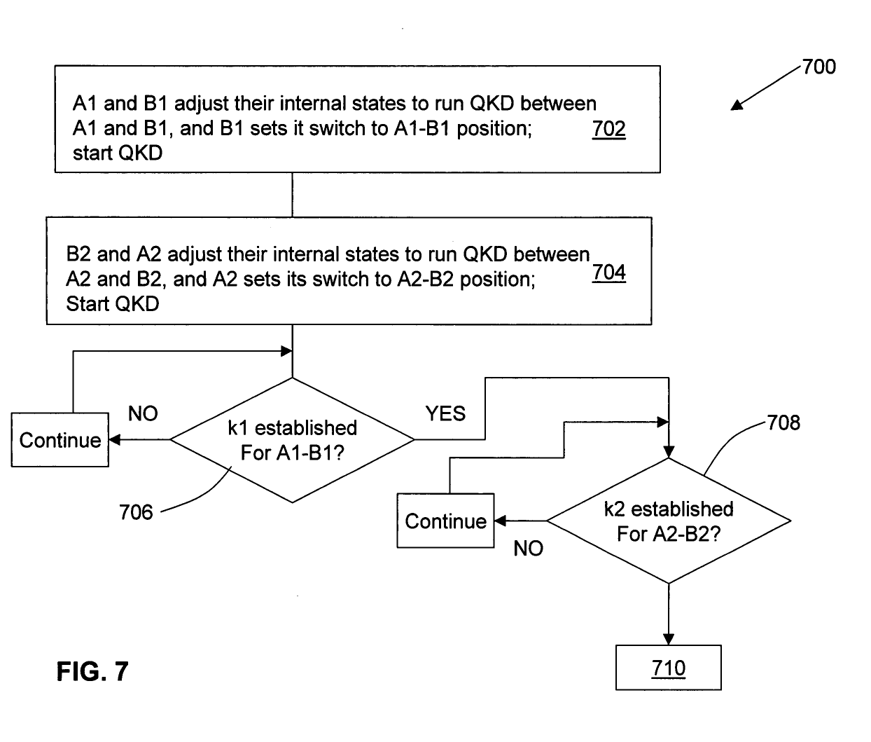

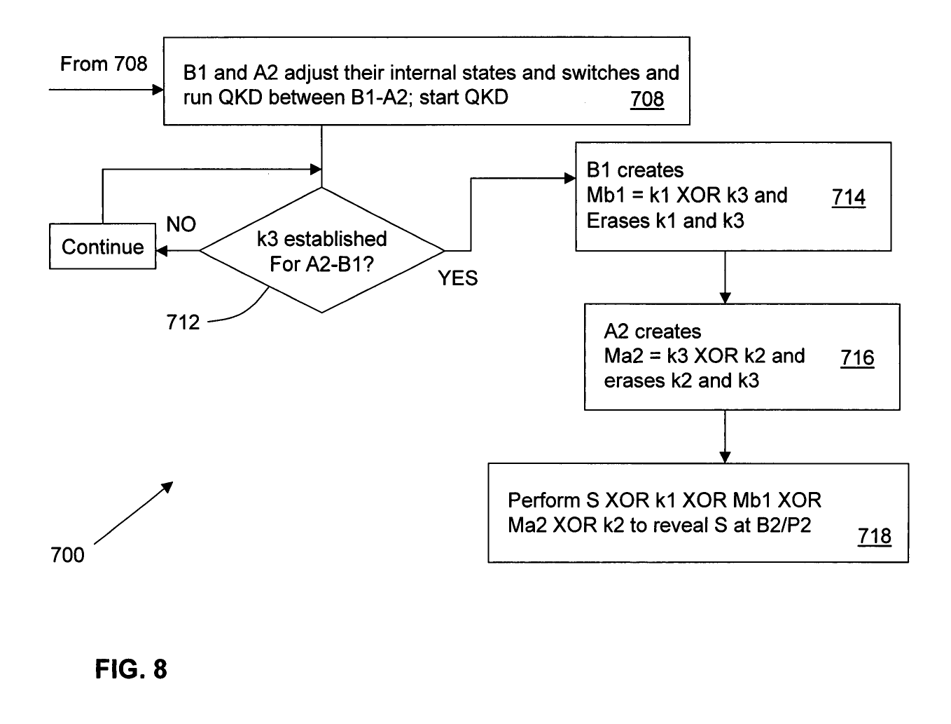

FIGS. 7 and 8 set forth a flow diagram 700 that illustrates an example embodiment of the operations needed to transmit a secret key S from P1 to P2 in QKD system network 200 of FIG. 5.

With reference first to FIG. 7, in 702, station A1 sends to station B1 a signal to start QKD process between stations A1 and B1. Also, station B1 sets its switch in corresponding position. In 704, station B1 sends station A2 a signal to start a QKD process with station B2. Also, station A2 sets its switch into corresponding position. In 706 and in 708, transmission continues between the stations until keys k1 and k2 are established.

After stations A1 and B1 establish a key k1, and stations A2 and B2 establish key k2, then with reference to FIG. 8, in 710 stations B1 and A2 set their switches to position B1-A2 start the QKD exchange between each other. In 712, the exchange continues until a key k3 is established. After key k3 is established between stations B1 and A2, then in 714, station B1 forms and records mb1=k1 XOR k3 and erases k1 and k3, and in 716 station A2 forms and records ma2=k3 XOR k2, and erases k3 and k2.

Finally, in 718, the secret key S is transmitted from P1 to P2 over public channel links A1-B1, B1-A2, A2-B2. The P1-A1 site sends ca1=S XOR k1 to B1, B1 creates cb1=ca1 XOR mb1 and sends it to A2. A2 then creates ca2=cb1 XOR ma2 and sends it to B2. At the B2-P2 site, the final operation ca2 XOR k2 yields S. Unlike the prior art (see, e.g., C. Elliot, New Journal of Physics 4 (2002) 46.1-46.12, referenced above), the secret key S is not revealed in the clear at each intermediate station.

With reference again to FIG. 6, the present invention includes a more complex, “two-dimensional” mesh or grid QKD system network 300, wherein each QKD station therein has a 1×4 switch. Suppose a user terminal P1 is attached to a station A11, and a user terminal P2 is attached to a B34 station. A secret key S can be transmitted from P1 to P2, say, through the A11-B21-A22-B23-A33-B34 chain. In this case, in phase 1 keys are established between A11-B21, A22-B23 and A33-B34 stations. In phase 2 keys are established between B21-A22 and B23-A33 stations. Stations B21, A22, B23 and A33 keep XORed keys established with neighboring stations.

Mesh grid QKD system 300 has several advantages. First, if at least one link or path between QKD stations is broken or compromised, another path can be quickly established by the QKD station controllers. Second, each time a secret key is transmitted from one user terminal to another, another route can be chosen, so that Eve couldn't know which link or station to crack. It should be noted that according to Federal Information Processing Standards (FIPS), the intermediate stations would need to be tamper-proof.

In the foregoing Detailed Description, various features are grouped together in various example embodiments for ease of understanding. The many features and advantages of the present invention are apparent from the detailed specification, and, thus, it is intended by the appended claims to cover all such features and advantages of the described apparatus that follow the true spirit and scope of the invention. Furthermore, since numerous modifications and changes will readily occur to those of skill in the art, it is not desired to limit the invention to the exact construction, operation and example embodiments described herein.

1. A QKD network system, comprising:
a first QKD station and a second QKD station;
a relay station that operably couples the first and second QKD stations, wherein the relay station includes a single third QKD station and an optical switch that allows the third QKD station to alternately communicate with the first and second QKD stations so as to establish a common key between the first and second QKD stations.

2. The system of claim 1, wherein the third QKD station includes a quantum optics layer and a controller each coupled to the optical switch.

3. A method of communicating a secure key S from an end-users P1 to and end user P2, with end-users P1 and P2 respectively coupled to first and second QKD stations A1 and B1, which are operably coupled to one another via a relay station that includes a single third QKD station B and an optical switch, the method comprising:
a) setting the switch to exchange a key k1 between stations B and A1;
b) setting the switch to exchange a key k2 between stations B and A2;
c) performing c=k1 XOR k2 at B;
d) performing c1=S XOR k1 at P1 and sending c1 to B;
e) performing c2=c1 XOR c at B;
f) sending c2 to P2 via A2; and
g) performing P2 XOR k2=S at P2.

4. The method of claim 3, including erasing keys k1 and k2 after establishing key c.

5. A method of communicating a key S between end-users P1 and P2 over a QKD system network having a linear configuration of QKD stations A1-B1-A2-B2, with end-user P1 operably coupled to A1 and end-user P2 operably coupled to P2, the method comprising:
setting an optical switch in B1 that allows communication between B1 and A1 and establishing a first key k1 between A1 and B1;
setting an optical switch in A2 that allows communication between B2 and A2 and establishing a second key k2 between A2 and B2;
setting the optical switches in B1 and A2 that allows communication between B1 and A2 and establishing a third key k3 between B1 and A2;
forming a key Mb1=k1 XOR k3 in B1;
forming a key Ma2=k3 XOR k2 in A2; and
performing S XOR k1 XOR Ma2 XOR k2 to reveal S at P2.

6. A method of communicating a secret key S from a first end-user P1 to a second end-user P2 both operably linked to respective first and second QKD stations in a QKD system network, the method comprising:
establishing a first key between the first QKD station and a third QKD station in a relay station by arranging an optical switch to be in a first state;
establishing a second key between the second QKD station and the third QKD by arranging the optical switch to be in a second state;
combining the first and second keys in the third QKD station; and
using the combined key in the third QKD station to communicate the secret key S from P1 to P2.
